(19) United States
(12) Patent Application Publication
(10) Pub. No.: US 2006/0294211 A1
(43) Pub. Date: Dec. 28, 2006

(54) Forwarding table synchronization for virtual environments

(76) Inventor: Nicholas Amato, Walnut Creek, CA (US)

Correspondence Address: PERKINS COIE LLP, P.O. BOX 2168, MENLO PARK, CA, 94026, US

(21) Appl. No.: 11/390,992

(22) Filed: Mar. 27, 2006

Related U.S. Application Data
(60) Provisional application No. 60/665,201, filed on Mar. 25, 2005.

(51) Int. Cl. G06F 15/177

(52) U.S. Cl. 709/220

(57) ABSTRACT

System architectures and protocols are described to synchronize forwarding state across redundant control planes in a computer network. Clusters of network devices include multiple agents, which are either in active or inactive mode. Each such agent is associated with a Forwarding Information Base (FIB), which stores network path information for communicating with network destinations. Updates to the Forwarding Information Bases are shared amongst the agents in a cluster by use of a network communications protocol. The protocol includes features that ensure that the active/inactive status of agents can be changed immediately, and that the FIBs in a cluster are consistent at all times, in order to ensure that network forwarded by a cluster will not be disrupted in the event of a failure of an active agent. Agents may be designated as either masters or slaves, which determines which determines the hierarchy in which FIB entries and written to and read by agents.

### CROSS-REFERENCE TO RELATED APPLICATIONS

This invention claims priority to U.S. Provisional Application 60/665,201, dated Mar. 25, 2005, which is hereby incorporated by reference in its entirety.

### FIELD OF THE INVENTION

The invention relates to the field of computer networking, and more specifically, to systems and methods for ensuring consistent routing in the event of system failures.

### BACKGROUND

High availability (HA) is one of the most important characteristics of modern network equipment. The first step in achieving high availability is to ensure that traffic continues to flow, even in the event of a control plane failure (regardless of whether the failure is hardware or software related).

The term, “high availability” has several connotations. Various terms and metrics have come about in the industry to describe individual HA offerings, for example, non-stop forwarding, non-stop routing, “five-9's” uptime and so on. In addition to the varied terminology, many different technologies have been developed to implement an HA architecture. But the common objective of all of these variants is to guarantee consistent, reliable flow of network traffic. Hence, non-stop forwarding (the ability to continue to forward data, even in the event of a control plane failure) is the primary step in building an HA architecture.

For simpler architectures, such as “appliances” operating on a network, clustering is often the solution of choice for achieving non-stop forwarding of network traffic. A “cluster” may include one or more network devices that comprise several “agents”, one of which is active to route forward network traffic destined for the cluster. The designation of the active agent may change, for instance, in the event of a failure of the previously active agent.

There is a need for a system architecture and protocol to ensure consistency amongst agents, so that the routing information contained in such agents is updated in real-time, in a manner that ensures that agents can be re-designated at any time, without any disruption in the routing and forwarding of network data. These and other objectives are addressed by this invention.

### SUMMARY

The invention includes system architectures and protocols to synchronize forwarding state across redundant control planes in a computer network. These embodiments facilitates non-stop data forwarding in the network, while ensuring minimal downtime, and allowing network topology to be reconfigured without loss of packets, and while minimizing any disruption or delay to network traffic.

The embodiments of the FTS invention can operate in virtual communication environments or non-virtual communication environment or any combination of virtual/non-virtual environments. Forwarding table states may virtual or non-virtual.

In embodiments of the invention, clusters of network devices include multiple agents, which are either in active or inactive mode. Each such agent is associated with a Forwarding Information Base (FIB), which includes network path information for communicating with network destinations. In embodiments of the invention, updates to the Forwarding Information Bases are shared amongst the agents in a cluster by use of a network communications protocol. The protocol includes features that ensure that the active/inactive status of agents can be changed immediately, and that the FIBs in a cluster are consistent at all times, in order to ensure that network forwarded by a cluster will not be disrupted in the event of a failure of an active agent.

Embodiments of the invention further allow agents to be designated as either masters or slaves, and use this status to determine how FIBs are to be updated amongst a cluster. In some embodiments, agents may be both masters and slaves for different clusters, allowing the agents to be ordered in a hierarchy that determines the manner in which FIBs are updated. These and other embodiments are further described herein.

### BRIEF DESCRIPTION OF FIGURES

FIG. 1 illustrates a master—slave hierarchy of network clusters in accordance with embodiments of the invention.

FIG. 2 illustrates a state machine for network agents in a cluster, in accordance with embodiments of the invention.

FIG. 3 illustrates an algorithm for determining the state of an agent on a network, in accordance with embodiments of the invention.

FIG. 4 illustrates an algorithm for processing update and delete messages in a FIB synchronization protocol, in accordance with embodiments of the invention.

FIG. 5 illustrates an Application Programming Interface accessible to an agent in a cluster in accordance with embodiments of the invention.

FIG. 6 illustrates a master—slave cluster hierarchy in accordance with embodiments of the invention.

### DETAILED DESCRIPTION

1. Overview

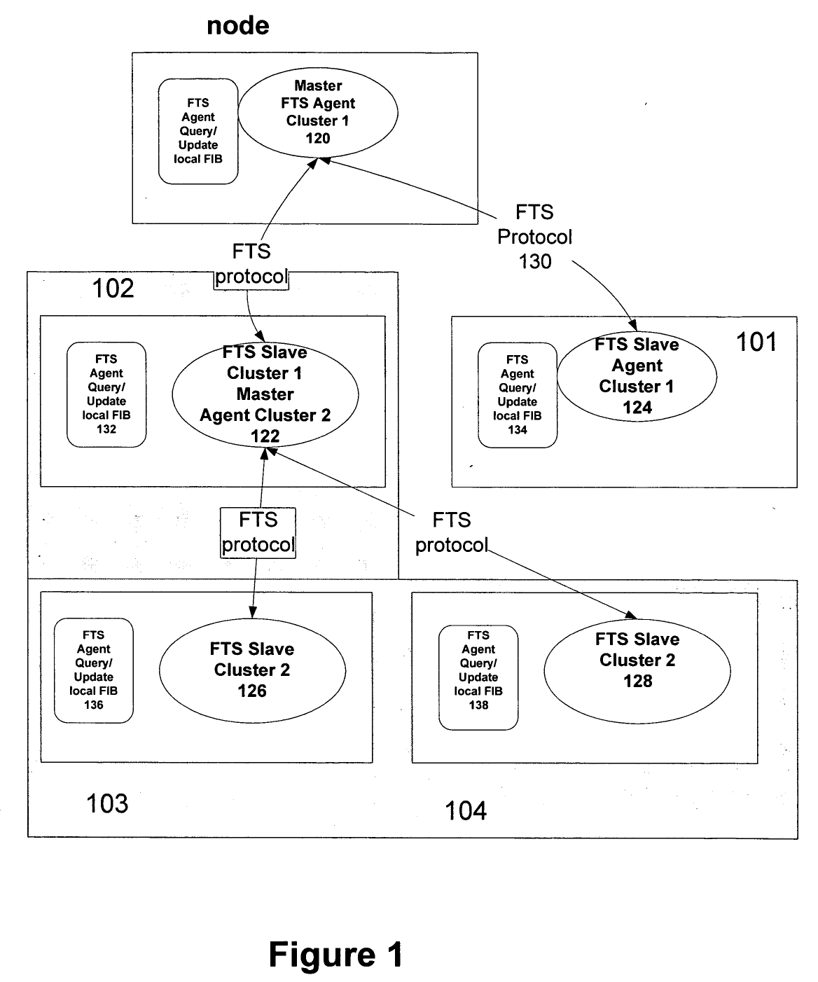

The invention includes a Forwarding Table Synchronization (FTS) Manager and an inter-agent communication protocol, the Forwarding Table Synchronization (FTS) Protocol, which provides for efficient distribution of forwarding table entries across a network. FIG. 1 schematically illustrates a network system architecture in accordance with embodiments of the invention. A plurality of agents 120 122 124 126 128 and the FTS protocol 130 132 134 136 138 enable the synchronization of multiple virtual Forwarding Information Bases (FIBs), scale to large numbers of routes, minimize utilization of network resources, and provide for future extensibility. Destination network addresses included in a FIB may be of any type, including, by way of example and not limitation, IP v 4 addresses, IP v 6 addresses, layer 2 addresses, MAC addresses, or other types of network addresses that will be apparent to those skilled in the art.

In embodiments of the invention, the FTS Manager is implemented as one or more independent software processes. In some embodiments, the FTS Manager may be implemented as one or more software agents (sometimes referred to herein as “FTS Agents”), each of which operates in either master or slave mode. An FTS agent is a software module that is responsible for synchronizing Forwarding Information Base (FIB) entries among a set of a machines. These machines may operate as normal network devices or as virtual devices with a Virtual Routing/Forwarding Tables.

Each FTS agent is responsible for one or more virtual routing/forwarding tables (VRFs). Each VRF table is uniquely defined by an identifier that is significant within the scope of a set of Agents. Such a set of agents is termed a “cluster”. Agents are not assumed to have the same set of virtual tables, but are assumed to know the scope of a table identifier.

In embodiments of the invention, a Master Agent (or Master FTS Agent) is responsible for distributing routing information (i.e., FIB entries) over the network to one or more Slave Agents in a cluster. The Master FTS Agent registers to receive routing table information from its local system, and listens for Slave Agents to attach to the Master agent's process. Each slave agent in a cluster listens to the Master agent for new routes to be added to its FIB, and behaves identically to the master when forwarding packets; the master is responsible for distribution of virtual FIB entries to the other agents operating in slave mode. An Agent may operate as either Master or Slave, transitioning between the two during its lifetime. Embodiments of the invention include mechanisms to allow dynamic changes of the Master/Slave state, as further described herein. Furthermore, an agent that is a slave with respect to a first cluster may be a master with respect to a second cluster.

An Agent (either Slave or Master) is associated with one or more virtual routing tables, referred to as VRFs (Virtual Routing/Forwarding tables). In embodiments, each table is identified by a unique 32-bit table identifier that is significant within the scope of a set of Agents; other suitable identifiers shall be apparent to those skilled in the art. Upon starting up or entering the Master state, the FTS agent queries the full table and request any forwarding/route table changes to be sent from the local kernel to the master agent.

In embodiments of the invention, the FTS protocol includes a set of operations/protocol messages for inter-agent communication, and a Finite State machine to connect FTS agents, pass routing/forwarding table information (VRF tables) and disconnect the agents. In some embodiments, the messages are sent over TCP; other suitable protocols shall be apparent to those skilled in the art. The operations provide the ability to synchronize multiple tables between FTSP speakers using this set of messages.

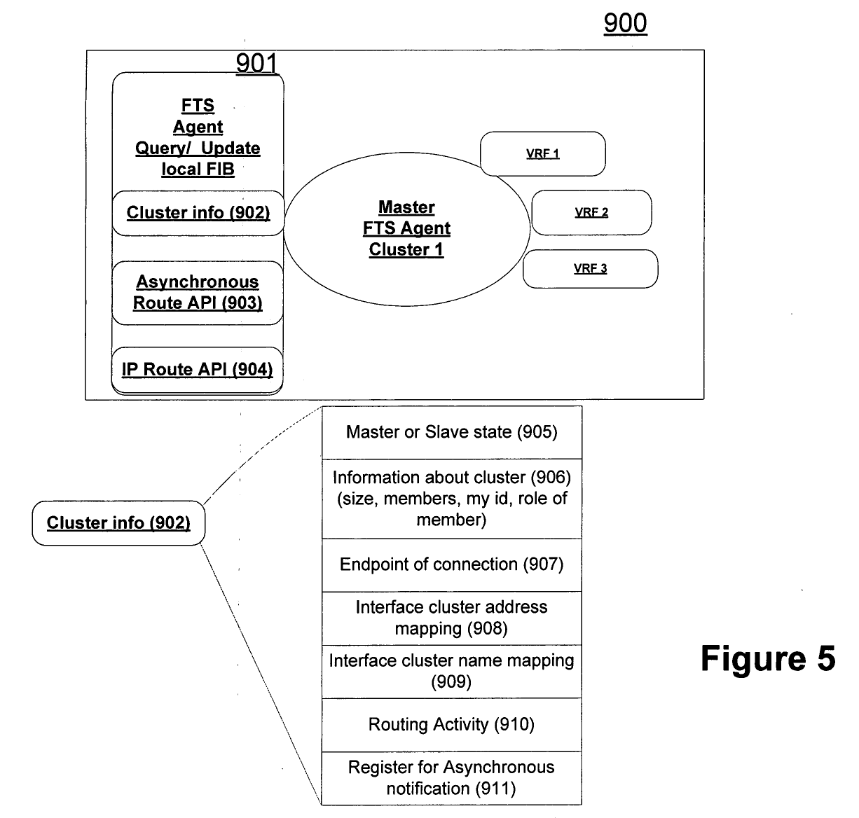

Embodiments of the invention further include a canonical Application Programming Interface (API) for facilitating interaction amongst the FTS Agents and network applications, as well as to allow individual FTS Agents to configure operational parameters such as logging, message connection endpoint address, and timers. The API 901 903 904 is schematically illustrated in FIG. 5, and may be further utilized to set or query the network application for numerous system parameters, including:
Master or slave state 905,
Information about clusters (size, members, my id, role_of_member) 906,
Determine the End-point ID of connection 907,
Determine whether interface names are consistent across virtual machines,
Determine interface cluster address mapping 908,
Determine cluster to interface name mapping 909,
Determine if there is routing activity 910,
Register for asynchronous notification 911

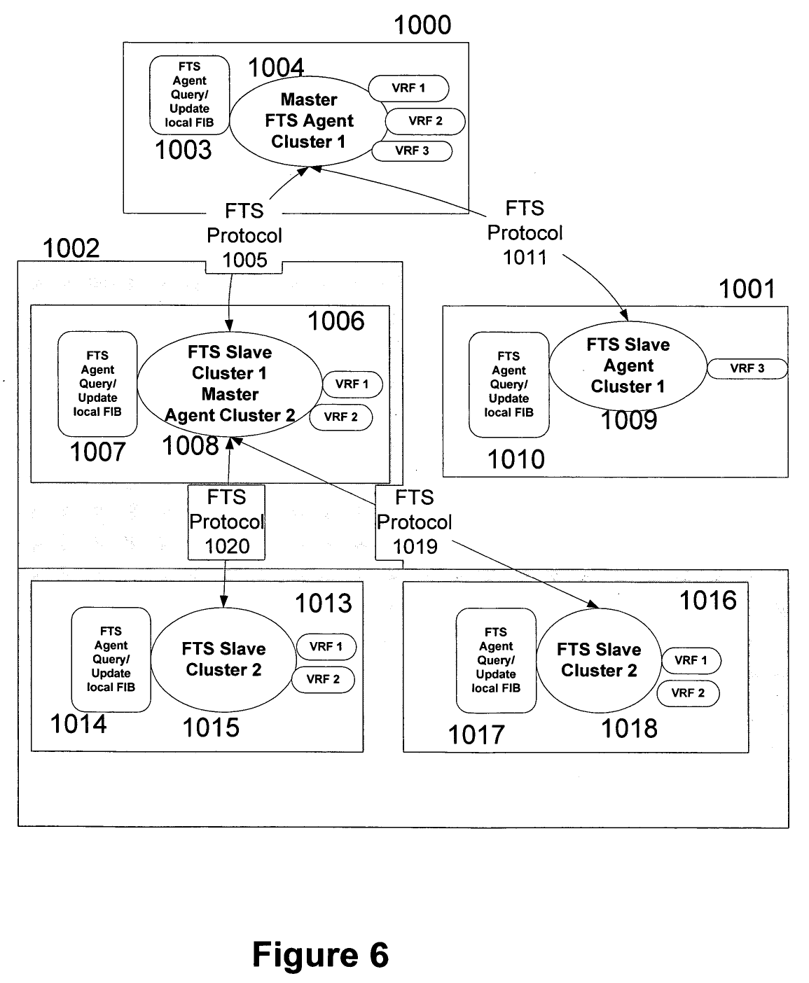

Embodiments of the invention include an FTS Agent API, that allows the FTS Agent to gather information from the FTS network application. By way of illustrative, non-limiting example, FIG. 6 shows APIs for each of the FTS Agents (Agent 1000's API is 1002, Agent 1001's API is 1010, Agent 1006's API is 1007, Agent's 1013 is 1014, Agent 1016 is 1017).

This invention supports high performance synchronization of FIBs between multiple process on multiple machines in normal, virtual routing environments, and cluster environments. Implementations of the invention can support millions of routes, hundreds of Virtual Forwarding Tables (VRF) and hundreds of FTS Agents.

In addition to the foregoing, Embodiments of the invention may include one or more of the following elements:
FTS Cluster Information—Information FTS queries from a cluster environment. This information includes (but is not limited to):
   Master and slave state
   An indication whether interface names are consistent across all cluster machines, and
   Cluster address to name mappings.
   FIG. 5 shows the FTS Cluster info API as a part of the FTS Agent API 902.
FTS Asynchronous notification—The FTS Agent API allows the FTS agent to register to receive asynchronous notification of change of network application information. (FIG. 5 shows illustrates setting of the FTS asynchronous notification feature as part of the FTS Agent API 903).
VRF—Virtual Routing/Forwarding Table that a FTS Agent synchronizes. The FTS method can support any address family or sub-address family. Non-limiting examples of address families supported herein include IPv4 and IPv6 address families with the Unicast and Multicast sub-address identifiers.
   FIG. 6 depicts an illustrative, non-limiting example of three VRFs associated with FTS Master Agent 1000: VRF 1, VRF 2, and VRF 3. FTS Agent 1001 supports VRF 3 only. FTS agent 1006, 1013, 1016 support VRF 1 and VRF 2.
VRF Table ID—A Virtual Routing/Forwarding Table ID is the identifier for a Virtual Table.
VRF Table Entry—A VRF table entry is the basic unit of VRF synchronization. For a IPv4 VRF Table entry this information may include one or more of: IPv4 prefix information, VRF Next Hop table index pointer, simple metric value, a complex metric table entry and flags. The next hop information may include a group of next hop entries each of which has: next hop table entry index,
Next Hop Table entry—A VRF NextHop Table entry contains information about the next hop forwarding for a single VRF table entry. Each Next Hop table entry has a index value (a Next Hop index value). The table entry contains all information necessary to forward information to the appropriate next hop(s). A Next Hop Forwarding table entry may be used for Unicast or Multicast information.
NextHop Table Entry Index ID—Index Id value for each entry
FTS Routing Table Activity—Changes in the FIB or VRF on the Master FTS Agent. The Master FTS Agent register to receive information on the FIB or VRF changes on its local node.
FTS Protocol (FTSP)—The FTS protocol utilizes FTS messages (OPEN, CLOSE, VRF Update, Delete) to establish a connection between FTS agents (Master and Slaves) and send information to synchronize FIBs. Each message contains certain Type-Length-Value (TLV) fields that may in turn contain Sub-TLVs for additional data. The protocol runs over a communication method determined by the FTS instance configuration.
   FIG. 6 illustrates an example implementation of the FTSP 1005 1011 1019 1020.
FTSP Neighbor Endpoint—The message connection (such as TCP) endpoint of an agent operating as a master.
   The FTS Agent a virtual communication end-point or provide multiplexing services for a group of virtual clients. In embodiments of the invention, an FTS agent may have a Master FTS service for a set of clusters and a Slave FTS Service for a different cluster of devices (physical or logical).
FTSP FSM: The Finite state machine for FTS protocol between Agents that governs initialization, connection establishment between agent, message passing, reconfiguration (from master to/from slave).
FTSP FSM Events: The events defined for the state machine for FTS Agents that governs initialization, connection establishment between agent, message passing, reconfiguration (from master to/from slave).
FTSP FSM Timers—The timers defined for the state machine for FTS Agents that governs initialization, connection establishment between agent, message passing, reconfiguration (from master to/from slave).
FTSP NextHop Index—Index ID for the FTS protocol's NextHop IP address that the packet will be forwarded to.
FTS Transport Protocol—The protocol that transport the FTSP protocol
   2. Methods for FTS Agents

Embodiments of the invention include a set of methods for Forwarding Table Synchronization (FTS) Agents that collude to distribute Virtual Forwarding/Routing Table (VRF) information.

The association between the agents can either be “pre-associated” (pre-configured) or associated in real time.

These methods include:
A method to allow an FTS agent to be either a master or slave within a set of associated FTS agents denoted as a cluster of FTS agents.
A method for Master FTS agent distributing Forwarding Table Information
   The Master FTS Agent accepts connections from its slave FTS agents and sends FIB information to synchronize the slave FTS Agent FIBs. Upon initial connection to the Master FTS agent, a FTS slave agent receives the current FIB for all VRFs from the FTS Master agents. After the initial connection, the FTS agent receives any route changes (add or deletes) to the FIB.
A method for a Slave FTS Agent receiving Forwarding Table information
A finite state machine automata that controls the transition between a plurality of states of FTS agents: un-initialized, Agent Slave or Agent Master and established connections between FTS agents.
   2.1 Master or Slave State within a Cluster of FTS Agents

A FTS Agent cluster may align with the network applications clustering (such as node clusters or virtual cluster). An FTS agent may serve as a Master FTS agent in one cluster, and a slave in another cluster of agents.

In embodiments of the invention, upon starting, the FTS Agent enters the “initializing” state, the following steps are completed:
1. Set the value of CurrentMode to Uninitialized,
2. Discard any stored routing information,
3. Cancel any running timers (RemnantDeletionTimer & ConnectRetryInterval)
4. Query the local system for the FTSAgent mode by using the external API call: api_cluster_state_get( ). This call returns the role of the FTS Agent as: CS_MASTER, CS_SLAVE or CS_NONE

At this point, the system, the local FTS Agent knows the status of Master or slave within the cluster. This status is saved in the CurrentMode global variable associated with each cluster. In addition, the FTS Agent determines, either by its configuration or via the api_cluster_state_get call, what cluster and VRFs this agent is attached to. If the FTS Agent is attached to two clusters, the FTS Agent will spawn a FTS agent per cluster.

Each cluster includes one or more of the following state machine variables. Note that the default values presented below are for example purposes only, and that other suitable values shall be apparent to those skilled in the art:
1. CurrentMode—The current mode of operation of an FTS Agent. This variable can be set to Master, Slave or uninitialized.
2. MasterEndpointAddress—the Transport endpoint address of the Master. (This variable has no meaning if the Agent is in the master State.)
3. AgentPort—The well known Transport port on which the Master Agent listens for incoming connections from slaves. The default value is decimal 2010.
4. ConnectionRetryInterval—The interval at which the Slave Agent is to retry initiating a transport connection. The default value is 5 seconds.
5. RemnantDeletionTime—the number of seconds a FTS Agent in the Master state waits before deleting any remaining Agent routes in the table. The default time is 60 seconds.

The MasterEndpointAddress, AgentPort, ConnectionRetryInterval, and RemnantDeletionTime can be set via configuration or default values. The CurrentMode is queried from the system for this cluster. MasterEndpointAddress may be queried from the target system for this endpoint.

If the node has multiple clusters, each cluster may be queried to determine if the local node is master and slave. An FTS Agent may be created per cluster.

After the FTS Agent state has been detected, the Initializing state also queries local routing information with:

api_get_all_vrf( ). This call is a wrapper on the system call to obtain the number of VRFs, and load them into a local routing table. If the new mode is CS_SLAVE, the FTS Agent queries for the MasterEndpointAddress via the call:

api_master_address_get( ).If the new mode is CS_MASTER, the FTS Agent transitions to the Agent Master state.

2.2 FTS Master Agent

Upon entering the FTS Master state, the FTS agent:
1. Sets the CS_MASTER state into the CurrentMode, and
2. Queries all VRF information on the local machine via api_get_all_vrf( ), and asks for asynchronous forwarding table updates via the api_notify_registero
3. Sets the value of Master Endpoint Address to one of its own endpoint address. This MasterEndpointAddress is set from either the local configuration of the Master Agent or queried via the api_master_address_geto.
4. Starts the RemnantDeletionTimer with a value for RemnantDeletionTime. When this timer fires, all remaining Agent routes in the routing table are deleted.

These external API calls (api_get_all_vrf( ), api_notify_register( ), api_master_address_get) translate to a series of calls to the target system that obtain the routing/forwarding table information to be passed per VRF.

In the Agent Master state, the FTS Agent listens on an AgentPort for incoming connections from FTS Slaves. If configured to listen to only listen on the MasterEndpointAddress, the Master FTS Agent will restrict acceptance of incoming transport connections from FTS Slave agents to those transport connections whose Destination address is the IP address of MasterEndpointAddress.

Upon receiving a OPEN message, the master agent:
Checks that the version advertised by the sender matches or is compatible with that of the receiver, and
Checks that there are sufficient resources to support the connection.

If either check fails, the Master agent receiving the OPEN can close the FTS protocol session by sending a Close message with the appropriate reason code in the message.

If the OPEN Message passes both tests, the Master FTS Agent sends the all register VRF information to Slave FTS Agent, via VRF Update messages. An further changes are transmitted to the Slave FTS Agent via VRF Update and VRF Delete messages.

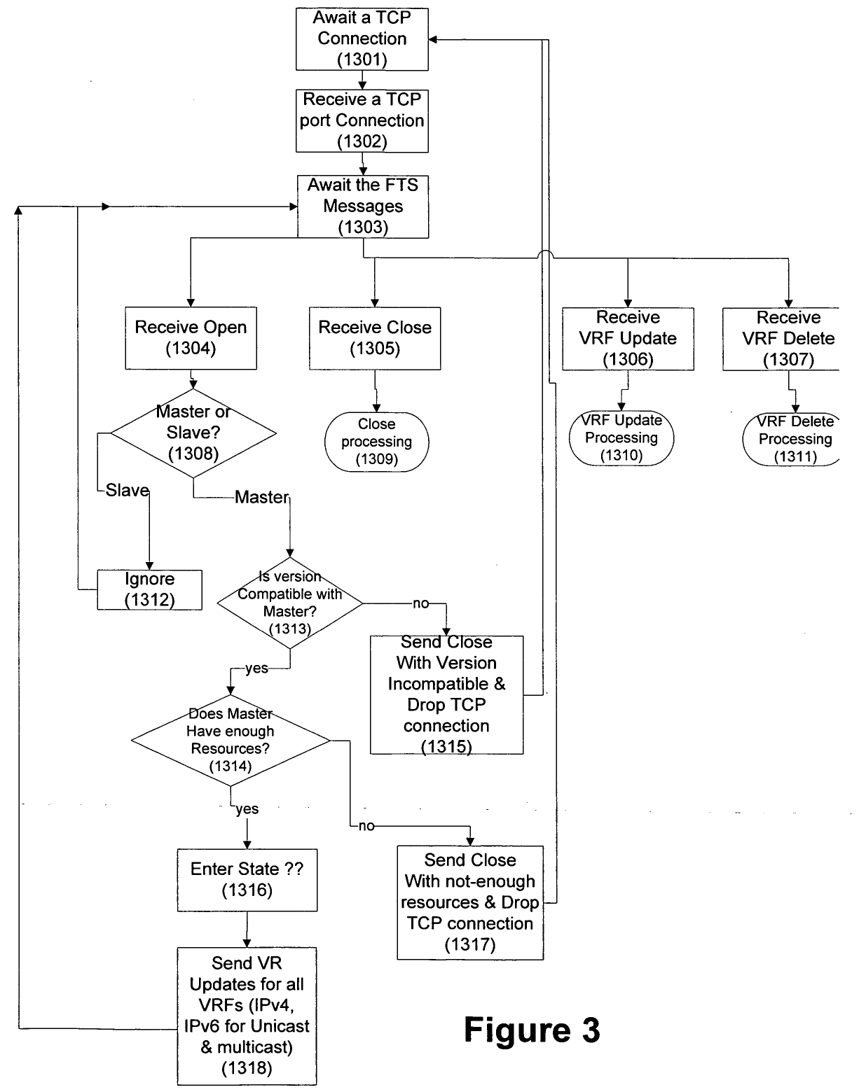

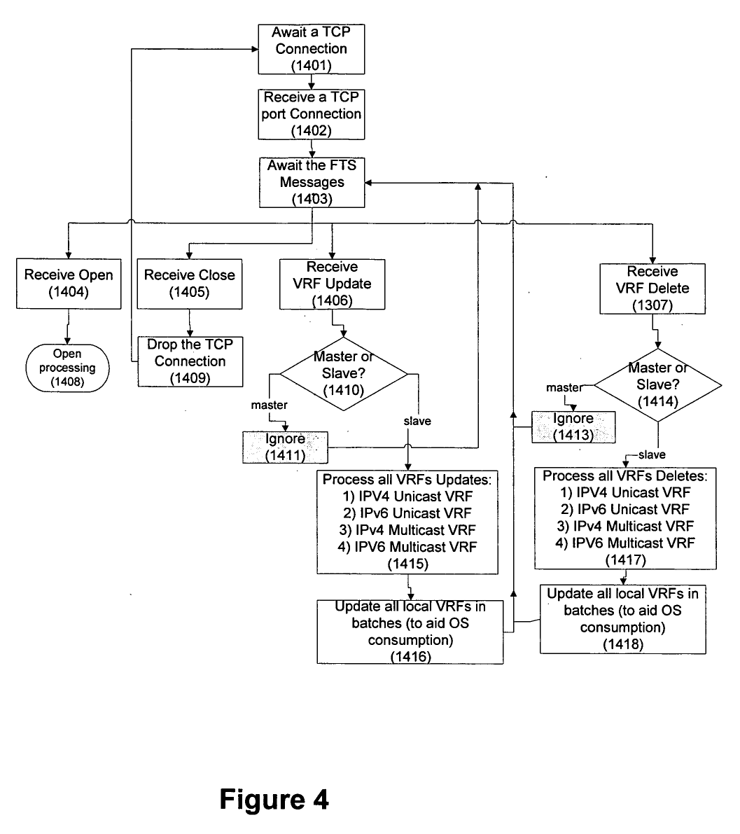

FIG. 3 illustrates the logic for the FTS protocol processing of the OPEN message. FIG. 4 illustrates the logic for the FTS protocol processing of the CLOSE, VRF Update and VRF Delete.

2.3. FTS Slave Agent

Upon entering the FTS Slave Agent state, the FTS Agent does the following:
1. Sets the CurrentMode to CS_SLAVE
2. Sets the MasterEndpointAddress to the transport endpoint address (e.g., by way of non-limiting example, the TCP Address) of the Master Agent,
3. Attempts to establish a Transport connect to the MasterAgents at MasterEndpointAddress. If the connection cannot be established, the ConnectRetryTimer is set to ConnectRetryInterval seconds. Upon the timer expiring, the Slave FTS Agent will attempt another connection.
4. Once a Transport session is established, the FTS Slave Agent sends an Open with a VRF Registration TLV to register for the cluster and VRFs configured for this cluster.

If the FTS Slave Agent receives a VRF Update or VRF Delete, the FTS agent updates the forwarding table to match the VRF function.

If the FTS Slave agent receives a Close message, the FTS agent will drop the TCP connection and set a ConnectionRetryTimer to ConnectRetryInterval. Upon the expiration of the ConnectionRetryTimer, the FTS Slave Agent will resume at step 3 of the above steps.

FIG. 3 illustrates the FTS protocol processing for the OPEN message and FIG. 4 illustrates the logic for the FTS processing of CLOSE, VRF Update, and VRF Delete.

2.4 Agent Finite State Machine

In embodiments of the invention, an FTS agent may be in any one of the following states: Initializing State, Agent Slave State, Agent Master State. The FTS Agent can handle the following events: 1) Master Change or 2) Shutdown in any state. Upon starting the FTS Agent, it goes into Initializing state.

The logic for the State transitions includes the following variables (default values stated below are for example purposes only—other suitable default values shall be apparent those skilled in the art):
Current mode—master, slave or uninitialized
MasterEndpoint address—Transport layer address of the master
Agent port—Well-known Transport Port on which the master Agent listens for incoming connections from slaves. (Default 2233).
ConnectionRetryInterval—The interval at which the Slave Agent is to retry initiating a TCP connection (Default 10 seconds)
RemnantDeletionTime—when in the Master state, the number of seconds to wait before deleting any remaining Agent routes in the table.
   2.4.1 Agent States

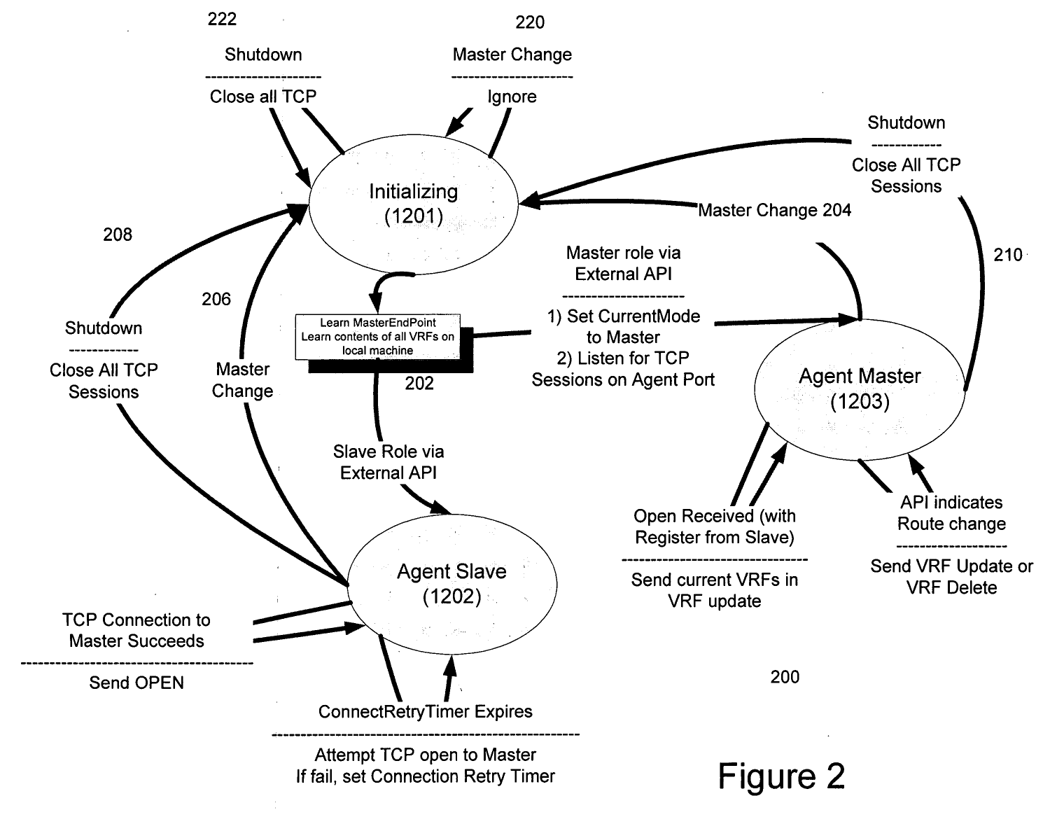

FIG. 2 illustrates a state machine 200 used by the Agents. As described above, the state machine references the following variables:
CurrentMode—The current mode of operation, set to either Master, Slave or Uninitialized.
MasterEndpointAddress—The TCP endpoint address of the master.
AgentPort—The well-known TCP port on which the Master Agent listens for incoming connections from slaves. As a non-limiting example, the default value may be set to decimal 2233.
ConnectionRetryInterval—The interval at which the Slave Agent is to retry initiating a TCP connection. As a non-limiting example, the default value may be set to 10 seconds.
RemnantDeletionTime—When in the Master state, the number of seconds to wait before deleting any remaining Agent routes in the table. As a non-limiting example, the default value may be set to 60 seconds.

For the purposes of discovering changes in this information, the Agent registers to receive a signal (which may, by way of non-limiting example, be implemented as SIGHUP) when the current state and endpoint address change.

2.4.2 Initializing State

Upon starting 1201, an Agent enters the Initializing state and the value of CurrentMode is set to Uninitialized. Any stored information relating to local FIB entries is discarded. If the RemnantDeletionTime timer is running, it is cancelled. The Agent then determines the following:
Its new mode of operation, Master or Slave. This is learned through an external API.
If the new mode is Slave, then the value of MasterEndpointAddress is learned 202.
The contents of all VRFs on the local machine. This is determined by reading the Linux protocol field of the route (or some route identifier in other systems, as will be readily apparent to those skilled in the art).

After reading this information, the Agent transitions to either the Agent Slave state 1202 or the Agent Master state 1203, depending on which mode is determined from the external mechanism.

The Agent can then process the following events in this state:
Master Change 220—This event does not have significance in this state. The Agent does not leave the Initializing state until the above information is learned.
Shutdown 222—Upon receipt of this event, the Agent closes all TCP connections and shuts down gracefully.
   2.4.3 Agent Slave State

In the Agent Slave state 1202, the Agent connects to the endpoint of another Agent determined to be the master, receives VRF entries, and updates the VRFs on the local machine. The VRF entries are communicated from the master in the form of IPv4 VRF Entry TLVs which are described further herein.

Upon transitioning to this state, the Agent sets CurrentMode to Slave and sets the value of MasterEndpointAddress to the TCP endpoint address of the Master Agent, after which the following actions are performed:
Open a TCP connection to the Master Agent at MasterEndpointAddress. If the connection cannot be established, retry the connection every ConnectionRetryInterval seconds.
Once the TCP connection is established, send an Open message (as described hereinafter) and register for the configured VRF entries using the VRF Registration TLV if applicable

The Agent makes a request for all VRF entries if it is possible that updates have been missed between sessions. The Agent maintains a transport connection to the Master Agent while in the Agent Slave state. If at any time the underlying transport connection is broken or a Close message is received, the Agent continues to retry the connection every ConnectionRetryInterval seconds until the connection is restored and normal VRF entry processing is resumed.

The Agent can process the following events in this state:
Master Change 206—Upon receipt of this event, the Agent transitions to the Initializing state.
Shutdown 208—Upon receipt of this event, the Agent closes all TCP connections and shuts down gracefully.
   2.4.4 Agent Master State

In the Agent Master state 1203, the Agent monitors routing information in all VRFs on the local machine. Agents operating in Agent Slave may connect and register for updates. Routing information for registered VRFs is transmitted by the master to all listening slaves in VRF Update and VRF Delete messages.

Upon transitioning to this state, the Agent sets CurrentMode to Master and sets the value of MasterEndpointAddress to one of its own endpoint addresses. This address may be learned through an API if necessary. The Agent then performs the following actions:
Listen for TCP connections on AgentPort. If configured to listen only on MasterEndpointAddress, the Agent may restrict connections to those that connect to this address.
Respond to and update any slave Agents that connect and register for VRFs, using the VRF Update and VRF Delete messages, as hereinafter described.

The Agent may process the following events in this state:
Master Change 204—Upon receipt of this event, the Agent transitions to the Initializing state.
Shutdown 210—Upon receipt of this event, the Agent closes all TCP connections and shuts down gracefully.
   2.4.5 Agent Events

2.4.5.1 Master Change

In embodiments of the invention, the Agent is continuously monitoring the master/slave state from the external API or is receiving asynchronous notifications of changes. The current mode as well as the endpoint address of the master are monitored. If a change is indicated in either of these values, the Master Change event is executed.

2.4.5.2 Shutdown

This event is executed when a graceful shutdown is requested. The Agent sends a Close message before terminating any TCP connections.

3. Applications of the FTS Manager and Agents

The invention for synchronization of forwarding table entries between a set of machines, allowing them to forward data in a consistent manner.

One non-limiting example of this functionality is within a cluster configuration in which multiple machines are forwarding data (i.e. load balancing) which allows for the failure of one or more machines without an interruption in forwarding of network traffic. As illustrated in FIG. 1, an agent that is a slave for a first cluster (Cluster 1) 122 can be a master for a second cluster (Cluster 2). Alternative embodiments include a high availability mode where all machines have consistent FIB entries, but only one participates in forwarding of data. In both types of embodiments, FIB synchronization allows fail-over of routing participation to another machine, such that data can continue to be forwarded while a control plane (i.e. a routing process) relearns its database.

4. API Calls and FTSB Protocol

The FTS Agent provides a functional call interface to the network applications. These applications pass back the information indicated in response. This APIs provides an abstraction layer for information retrieved from network applications

4.1 Data Structures Used by API

As a non-limiting example, the following data structure can be utilized by the example API described herein.

| | |
|---|---|
| typedef enum | { CS_NONE, |

CS_MASTER,
CS_NOT_MASTER} cluster_state_t;

struct_sockaddr *api_master_address_get(void)
typdef enum {

NOTE_GOOD,
NOTE BAED

| } cluster_pnote_t; | |
|---|---|
| Extern cluster_state_t mode; | # cluster mode |
| Extern int same_int; | # same interface names |

4.2 FTS Agent API

This FTS Agent API puts a wrapper on specific Cluster information calls to get information.

struct sockaddr *api_master_address_get(void)
function: calls target specific _* functions to get Master FTS
Agent's IP address.. These calls query the customer's cluster
information.

| | |
|---|---|
| arguments: | none |
| return code: | sockaddr * ip-address - address of the |

master on the sync network
cluster_state_t api_cluster_state_get(void)
function: calls target specific functions to get cluster
information: These calls areget the node id, IP address, and
role the node plays.

| | |
|---|---|
| arguments: | none |
| return code: | role (CS_NONE, CS_MASTER, |

CS_NON_MASTER)

int api_same_int_status_get(void)
function: calls target specific functions to find out if the
cluster application uses the same interface names.

| | |
|---|---|
| arguments: | none |
| return code: | < 0 - failures, 0 or > 0 = success |

int api_notify_register(void)
function: calls customer register functions to start register
to receive asynchronous updates.

| | |
|---|---|
| arguments: | none |
| return code: | < 0 - failures, 0 or > 0 = success |

int api_notify_unregister(void)

| | |
|---|---|
| function: | Calls customer unregister functions to stop |

receiving asynchronous updates.

| | |
|---|---|
| arguments: | none |
| return code: | < 0 - failures, 0 or > 0 = success |

int api_cluster_address_from_name(char *name, u_int32 *ip,
u_int32 *mask);
function: calls cxl_* functions to get cluster IP address (ip
and mask) from name. The cxl_* functions called is:
cxl_get_cluster_info-from_member_if_name(name,ip,mask)

| | |
|---|---|
| arguments: | char *name - name of the interface |

u_int32 *ip - pointer to IP address
u_int32 *mask - pointer to IP address
mask

| | |
|---|---|
| return code: | −1 - failures, 0 = success |

int api_cluster_name_from_address(u_int32 ip, u_int32 mask,
char **name);
function: calls target specific functions to obtain the cluster
name from the IP address.

| | |
|---|---|
| arguments: | char **name - pointer to the pointer of |

the name of the interface
u_int32 *ip - pointer to IP address
u_int32 *mask - pointer to IP address mask

| | |
|---|---|
| return code: | −1 - failures, 0 = success |

int api_get_vrf_ids(u_int32 *id, char *name, u_int32 ip,
u_int32 mask);

| | |
|---|---|
| arguments: | id - array of VRF IDs |

char *name - pointer to the pointer of the name of the

interface

u_int32 ip - IP address of cluster
u_int32 mask - IP address mask for cluster

| | |
|---|---|
| return code: | −1 - failures, 0 = success |

iapi_get_all_vrf(void);

| | |
|---|---|
| return code: | −1 - failures, 0 = success |

5. Forwarding Table Synchronization Protocol

Embodiments of the invention include an FTS protocol for communication amongst agents. Examples of messages used in embodiments of the protocol are provided herein, and agent responses to protocol messages are illustrated in FIG. 3 and FIG. 4.

5.1 Protocol Messages

Each message consists of a fixed-length header followed by a set of TLV (Type, Length, Value) entities. Unrecognized TLV entities and message types are ignored and do not cause the connection to be terminated if present. TLVs (and SubTLVs) can appear in any order when a packet type allows multiple types.

In embodiments, the TCP session openings are deterministic. This determinism is provided by an external API that dictates the state of the agent and master endpoint in a deterministic manner.

5.2 Message Header

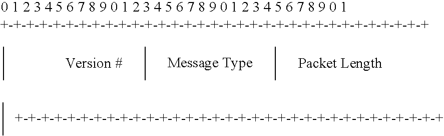

In embodiments of the invention, this 32-bit fixed-length message header appears at the beginning of all protocol messages. The Version field is the same for the lifetime of a connection. If an Agent is unable to support a version sent by another Agent, the connection can be closed. An Agent can downgrade its version for the purpose of compatibility with another Agent.

The component values are:
Version—The version of the protocol in use by the sender. The value is 1.
Message Type—The type of the message.
Packet Length—The length of the message, including the header.

5.3 Open Message

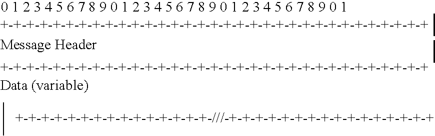

This message is the first message sent by the opener of the TCP connection after the TCP link is established.

Header Values
Version—The version of the protocol in use by the sender. The value is 1.
Message Type—The Open message is type 1.
Packet Length—The length of the message, including the header.

Processing

In some embodiments, only an Agent operating as a slave sends the Open message. The master Agent performs the following checks on receipt of this message:
Check that the version advertised by the sender matches or is compatible with that of the receiver 1313.
Check that there are sufficient resources to support the connection 1314.

If either of these checks fail, the receiver can close the session 1317 with an appropriate Reason Code in a Close message, as described herein.

TLV Entities Allowed

The following Type, Length, Value entities are allowed in the Open message:
VRF Registration TLV, as further described herein.

States

In some embodiments, this packet can only be sent from the slave state. Additionally, this packet can only be processed from the master state. It is ignored if it is received in any other state.

5.4 VRF Update

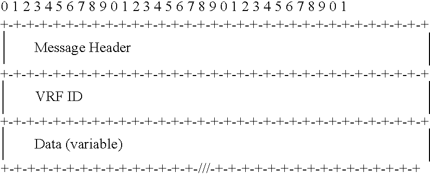

This message is used to communicate an update to a virtual forwarding table.

Header Values
Version—The version of the protocol in use by the sender. This value is 1.
Message Type—The VRF Update message is type 2.
Packet Length—The length of the message, including the header.

Processing

In some embodiments, only an Agent operating as a master sends the VRF Update message. The slave Agent performs the following actions upon receipt of this message:
Process all IPv4 VRF Entry TLVs 1415. If an entry has changed, override the current database entry with the new entry.
Update the local VRFs 1416 as necessary to reflect any new information. This is done in batches to prevent sending information to the forwarding plane too quickly.

TLV Entities Allowed

The following Type, Length, Value entities are allowed in the VRF Update message.
IPv4 VRF Entry TLV, further described herein.

States

In some embodiments, this packet can only be sent from the master state. Additionally, this packet can only be processed from the slave state. It is ignored if it is received in any other state.

5.5 VRF Delete

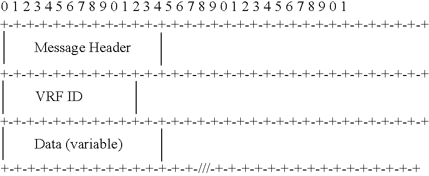

The VRF Delete message is used to communicate that an entry in a virtual forwarding table has been deleted.

Header Values
Version—The version of the protocol in use by the sender. This value is 1.
Message Type—The VRF Delete message is type 3.
Packet Length—The length of the message, including the header.

Processing

In some embodiments, only an Agent operating as a master sends the VRF Delete message. The Slave Agent performs the following actions on receipt of this message:
Process all IPv4 VRF Entry TLVs 1417. The entries in this type of packet are deleted from the local database.
Update the local VRFs 1418 to reflect any new information. This is done in batches to prevent sending information to the forwarding plane too quickly.

TLV Entities Allowed

The following Type, Length, Value entities are allowed in the VRF Update message.
IPv4 VRF Entry TLV, as further described herein.

States

In some embodiments, this packet can only be sent from the master state. Additionally, in some such embodiments, this packet can only be processed from the slave state, and is ignored if it is received in any other state.

5.6 Close

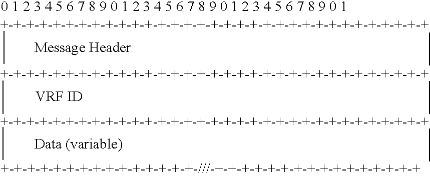

The Close message is used to communicate that the sender is closing the session. When possible, the Close message is sent before terminating any TCP connection. Upon receipt of this message, the receiver closes the TCP connection if it has not already been closed by the sender. This message effectively delimits the end of the session.

Header Values
Version—The version of the protocol in use by the sender. This value is 1.
Message Type—The Close message is type 4.
Packet Length—The length of the message, including the header. TLV Entities Allowed

The following Type, Length, Value entities are allowed in the Close message.
Reason SubTLV, as further described hereinafter.

States

This packet can be processed or sent from any state.

5.7 TLV Entities

VRF Registration TLV

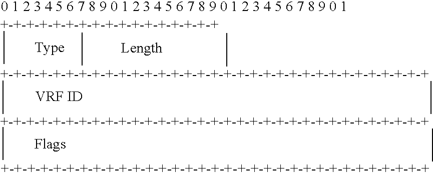

A sender uses this TLV to indicate to the receiver that the sender wants to monitor changes in a virtual forwarding table.
Type (0x02)—The type value of this TLV.
Length—The length of this TLV is always 8.
VRF ID—The VRF identifier for which the sender wants to register for updates.
Flags—The flags vector for this request.

The sender can set the flags vector to convey further information. Two flag values are defined here.

Upon processing a full update request, the receiver queues the contents of all VRFs for the requester. If the contents of the VRFs change while this snapshot is queued, the latest update is queued for the requester. Because the most recent update always represents the most current information, the requester can update the contents of the VRFs with the most recent message for a VRF entry when it arrives.
FULL_UPDATE_REQUEST (0x01)—When this flag is set, it indicates that the sender would like to receive a “snapshot” of the entire forwarding table with this VRF ID. If the flag is not set, only updates after the time of registration are sent to the sender.
ALL_VRF—(0x02) When this flag is set, it indicates that the sender would like to monitor changes in all virtual forwarding tables on the receiver's machine. When this flag is set, the value of VRF ID is ignored.

States

In some embodiments, this packet can only be sent from the slave state. Additionally, in some such embodiments, this packet can only be processed from the master state, and is ignored if it is received in any other state.

IPv4 VRF Entry TLV

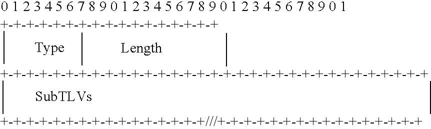

The IPv4 VRF Entry TLV is a top-level TLV that contains a set of SubTLVs.
Type (0x07)—The type value of this TLV.
Length—The length of this TLV, which is the collective length of all the enclosed SubTLVs.
SubTLVs—Zero or more SubTLVs describing the details of this entry.
   5.8 SubTLV Entities

In embodiments of the invention, the variable field format is made of TLVs. Each TLV may have multiple SubTLVs within it.

| | | | Agent State allowed to | | |
|---|---|---|---|---|---|
| | | SubTLVs | receive the TLV within message | | |
| | TLV entities | within | Receive | Receive | |
| | allowed within | TLV | and | and | |
| Message | Message | Yes/No | process | ignore | Send |
| OPEN | VRF | No | Master | Slave or | Slave |
| | Registration | | | initialized | |
| UPDATE | IPv4 VRF | Yes | Master | Slave/Init | Slave |
| VRF | Entry | | | | |
| | IPv6 VRF | Yes | Master | Slave/Init | Slave |
| | Entry | | | | |
| | IPv4 | Yes | Master | Slave/Init | Slave |
| | Multicast | | | | |
| | VRF Entry | | | | |
| | IPv6 | Yes | Master | Slave/Init | Slave |
| | Multicast | | | | |
| | VRF Entry | | | | |
| DELETE | IPv4 VRF | Yes | Master | Slave/Init | Slave |
| VRF | Entry | | | | |
| | IPv6 VRF | Yes | Master | Slave/Init | Slave |
| | Entry | | | | |
| | IPv4 | Yes | Master | Slave/Init | Slave |
| | Multicast | | | | |
| | VRF Entry | | | | |
| | IPv6 | Yes | Master | Slave/Init | Slave |
| | Multicast | | | | |
| | VRF Entry | | | | |
| CLOSE | Reason | No | Master | Never | Master |
| | | | or Slave | ignored | or |
| | | | or Unini- | | Slave |
| | | | tialized | | |

5.8.1 IPv4 Prefix SubTLV

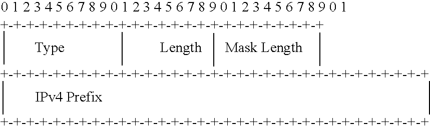

The IPv4 Prefix SubTLV indicates the key value for a forwarding table entry. Any received IPv4 Prefix SubTLV can be considered as the most recent forwarding table entry for its prefix. If the prefix did not exist in the local database, then a new one is created upon receipt of this TLV. If the TLV is received in a VRF Delete message, the prefix is deleted from the local VRF.

This prefix can be of variable length. The component values of this SubTLV are:
Type (0x01)—The type value of this SubTLV.
Length—The length of this SubTLV is always 5, or a variable depending on the mask length.
Mask Length—The mask length for this prefix. Acceptable values are 0 to 32 inclusive.
IPv4 Prefix—The 32-bit IPv4 address prefix of the forwarding table entry. This value, in combination with the mask, is considered a “key” value that may be used to uniquely identify an entry.

5.8.2 Flags SubTLV

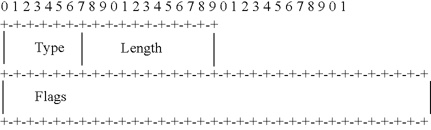

The Flags SubTLV exists to communicate only the flags entered by the operative routing algorithms into the forwarding table.
Type (0x03)—The type value of this SubTLV.
Length—The length of this SubTLV is always 4.
IPv4 Prefix—A 32-bit flag vector representing the forwarding table flags for this route. Possible flag values are:
   RTF_UP (0x01)—This flag indicates whether the entry is usable.
   RTF_REJECT (0x08)—This flag indicates whether the entry is a reject route.
   RTF_BLACKHOLE (0x08)—This flag indicates whether the entry will be kept in the table.
   RTF_END (0x11)—This flag indicates that this entry represents the last entry in the initial snapshot of data. Upon receiving an entry with this flag set, the (slave) receiver can delete any entries that were present at the opening of the connection but were not updated in the received snapshot.

5.8.3 IPv4 Next Hops SubTLV

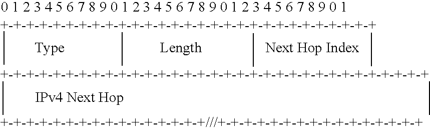

Type (0x05) - The type value of this SubTLV.
Length - The length of this SubTLV is either 0 or a multiple of five.
Next Hop Index - The index of this entry. This index is used to match other interface-related SubTLVs.
IPv4 Next Hop - The IPv4 Next Hop addresses for the entry. Each address is a 32-bit value. The entry cannot have a next hop.

This TLV can have zero or more next hop entries, each of which is five bytes long with an 8-bit index and a 32-bit Next Hop.

5.8.4 Metric SubTLV

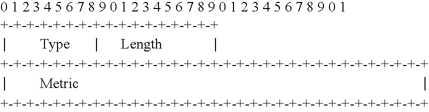

Type (0 × 08)—The type value of this SubTLV.
Length—The length of this SubTLV is always 4.
Metric—A 32-bit unsigned integer representing the metric for this forwarding table entry.

5.8.5 Interface Name SubTLV

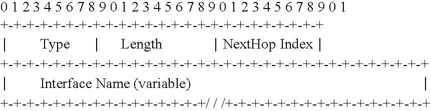

Type (0 × 18)—The type value of this SubTLV.
Length—The length of this SubTLV.
NextHop Index—The index of the next hop in the IPv4 NextHops SubTLV that is being referenced.
Interface Name—A string of up to 253 bytes representing the name of the outgoing interface for this entry (for example, eth0). The name is not zero-terminated.

5.8.6 IPv4 Interface Address SubTLV

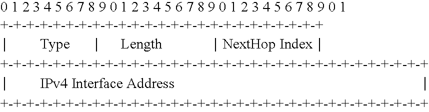

Type (0 × 24)—The type value of this SubTLV.
Length—The length of this SubTLV.
NextHop Index—The index of the next hop in the IPv4 NextHops SubTLV that is being referenced.
Interface Address—A 32-bit IPv4 address representing an address of the outgoing interface for this entry.

5.8.7 Reason SubTLV

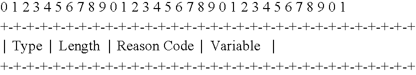

This TLV indicates a reason code for termination of the session. The Reason Code indicates a reason why the sender is terminating the session. After the Reason Code, a variable-length string containing more information about the termination may be present in this TLV. Example uses of this area are error strings such as, “malloc( ) failed” or “version number not understood”. If an error string is present, it is not zero-terminated.

Possible values of Reason Code are:
GOING_DOWN (0x01)—The sender is performing a graceful shutdown operation.
INTERNAL_ERROR (0x02)—The sender has encountered an internal unrecoverable error.
VERSION_INCOMPATIBLE (0x04)—The sending Agent does not want to speak the requested version of the protocol.
INSUFFICIENT_RESOURCES (0x08)—The sender does not have sufficient resources to support the connection.
STATE_CHANGE (0x09)—The sender is performing a state transition and has determined that it no longer wants to support this connection.
   6. Additional Functionality

This section outlines functionality that is present in the software agent.

6.1 Configuration

Configuration can be achieved through command-line flags. The following flags are supported:
−d file—This option enables debug tracing to the specified file.
−N—This option prevents the software agent from daemonizing.
−b a.b.c.d—This option causes the Agent to bind to the local IPv4 address a.b.c.d. If this option is not given, the Agent will bind to the INADDR_ANY address and accept TCP connections incoming on any interface. Note that this address can also be dynamically learned through an external API and can change during the lifetime of the agent.
−t time—This option sets the remnant deletion timer, in seconds.
   6.2 Logging

Important events, such as state changes, are logged to the system syslog facility. In addition, an optional file can be configured (using the −d option above) to contain debugging trace messages.

6.3 Signals

The software agent responds to the SIGTERM signal, which causes the agent to terminate gracefully, notifying all of its connected agents. The VRFs are not modified upon termination. The SIGHUP signal is currently used for asynchronous notification of changes in cluster state.

6.4 Extended Features

This section outlines extended TLV formats for distribution additional information between Agents.

6.5 IPv6 Prefix SubTLV

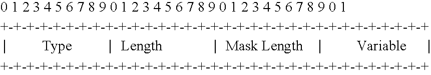

The IPv6 Prefix SubTLV indicates the key value for a routing entry. Any received IPv6 Prefix SubTLV should be considered as the most recent forwarding table entry for its prefix. If the prefix did not exist in the local database, then a new one should be created upon receipt of this TLV. If the TLV is received in a VRF Delete message, the prefix should be deleted from the local VRF.

It is expected that the IPv6 Link Local prefix will not be distributed between Agents because this represents an interface route that is not learned via the routing protocols.

The IPv6 Prefix SubTLV should not be in the same top-level TLV with an IPv4 Prefix SubTLV as they both represent key values for an entry. The prefix is of variable length, from 0 to 16 bytes.

The component values of this SubTLV are:
Type (0x06)—The type value of this SubTLV
Length—The length of this SubTLV is variable
Mask Length—The mask length for this prefix. All masks are assumed to be contiguous. Acceptable values are 0-32 inclusive.
Variable—The IPv6 address prefix of the forwarding table entry. This value, in combination with the mask, is considered a “key” value, i.e. it can be used to uniquely identify an entry.

6.6 IPv6 Interface Address SubTLV

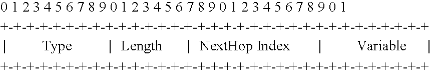

Type (0 × 25)—The type value of this SubTLV
Length—The length of this SubTLV
NextHop Index—The index of the nexthop in the IPv4 NextHops SubTLV that is being referenced.
Variable—An IPv6 address representing an address of the outgoing interface for this entry.

6.7 IPv4 Multicast Forwarding Cache SubTLV

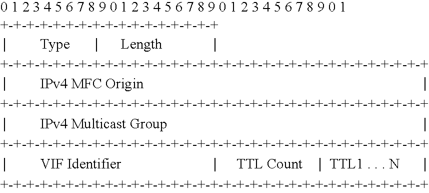

Type (0 × 26)—The type value of this SubTLV
Length—The length of this SubTLV
IPv4 MFC Origin—The IPv4 address that is originating the multicast data
IPv4 Multicast Group—The Class-D multicast address associated with this entry
TTL Count—A count of the number of 8-bit TTL values that follow
TTL1 . . . N—8-bit TTL values

The IPv4 MFC Entry SubTLV should not be mixed with IPv4 or IPv6 SubTLVs in the same entry top-level TLV.

7. Conclusion

The embodiments and implementations presented herein are for illustrative purposes only, but are not intended to limit the scope of the invention; many alternative embodiments and implementations shall be readily apparent to those skilled in the art.

1. A computer network system comprising:
a plurality of network agents for routing and forwarding network traffic, each of the plurality of network agents maintaining one or more forwarding information bases, each of the one or more forwarding information bases including network paths for a plurality of network destinations, wherein the plurality of network agents are in communication over one or more network protocols;
a logical network address, wherein each of the plurality of network agents are associated with the logical network address;
a plurality of physical network addresses, wherein each of the plurality of network agents is bound to at least one of the plurality of network addresses;
a synchronization protocol contained in the one or more network protocols, wherein the plurality of network agents are operative to exchange the one or more synchronization operations via the synchronization protocol;
a master network agent in the plurality of network agents, and a plurality of slave network agents in the plurality of network agents, wherein the master network agent is operative to read or write information to the forwarding information bases of the plurality of slave network agents via the synchronization protocol;
wherein the master network agent synchronizes the forwarding information bases in real-time.

2. The computer network system of claim 1, wherein only one live network agent from the plurality of slave network agents is operative to route and forward network traffic, and wherein the master network agent continuously updates one or more remaining slave network agents to ensure that the one or more remaining slave network agents is operative to forward and route network traffic if the live network agent is unavailable.

3. The computer network system of claim 1, wherein any one or more slave network agents from the plurality of network agents are operative to route and forward network traffic at any time, and wherein the master network agent is operative to ensure that the one or more slave network agents route and forward network traffic identically at all times during their operation.

4. The computer network system of claim 1, wherein the plurality of network agents are software modules operative on a single network device that is in communication with a computer network;

5. The computer network system of claim 1, wherein the plurality of network agents are software modules, and each of the plurality of network agents are resident on a distinct device from a plurality of network devices, the plurality of network devices in communication via one or more of a local area network, a wide area network, and a local bus.

6. The computer network system of claim 1, wherein the one or more network protocols includes TCP/IP.

7. The computer network system of claim 1, wherein the one or more forwarding information bases include IP v 4 addresses.

8. The computer network system of claim 1, wherein the one or more forwarding information bases include IP v 6 addresses.

9. The computer network system of claim 1, wherein each of the plurality of network agents is operative to be the master network agent or any one or more of the slave network agents.

10. The computer network system of claim 1, wherein each of the plurality of network agents includes a state machine, the state machine including one or more parameters defining the operation of the respective network agent.

11. The computer network system of claim 10, wherein the state machine for each of the one or more network agents includes a current mode parameter, the current mode indicating whether the network agent is the master network agent or one of the plurality of slave network agents.

12. The computer network system of claim 10, wherein the state machine for each of the plurality of network agents includes a master endpoint address, indicating the physical address of the master network agent.

13. The computer network system of claim 12, wherein the state machine for each of the plurality of network agents includes a parameter indicating an agent port over which the synchronization protocol is communicated.

14. The computer network system of claim 12, wherein the state machine for each of the plurality of network agents includes a parameter indicating a period at which a slave network agent is to retry initiation of a connection to the master network agent.

15. The computer network system of claim 12, wherein the state machine for each of the plurality of network agents includes a parameter indicating a number of seconds to wait prior to deleting routes from the forwarding information base of the network agent.

16. The computer network system of claim 1, wherein the synchronization protocol includes a plurality of synchronization operations.

17. The computer network system of claim 16, wherein the plurality of synchronization operations includes an open operation, which initiates communication between the master network agent and a slave network agent from the plurality of slave network agents.

18. The computer network system of claim 1, wherein a first one or more of the slave network agents comprises a master network agent for one or more other slave network agents in the plurality of slave network agents, such that the first one or more slave network agents are operative to read and write information to the forwarding information bases of the one or more other slave network agents via the synchronization protocol.

19. The computer network system of claim 1, wherein one or more of the forwarding information bases include a plurality of layer 2 addresses, and a plurality of network paths for reaching the plurality of layer 2 addresses.

20. The computer network system of claim 19, wherein the plurality of layer 2 addresses comprise MAC addresses.
